(19) United States
(12) Patent Application Publication
(10) Pub. No.: US 2009/0187748 A1
(43) Pub. Date: Jul. 23, 2009

(54) METHOD AND SYSTEM FOR DETECTING STACK ALTERATION

(76) Inventor: Scott Krig, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 12/017,625

(22) Filed: Jan. 22, 2008

(51) Int. Cl. G06F 9/30

(52) U.S. Cl. 712/227; 712/E09.023

(57) ABSTRACT

The disclosed systems and methods relate to employing one or more of machine instructions (i.e. assembler language instructions) to detect stack alterations. Aspects of the present invention also relate to employing CPU logic and one or more associated CPU registers to detect stack alterations. Aspects of the present invention may also relate to employing hidden content addressable memory (CAM) and registers that are only accessible by the CPU, and each cell in the CAM may be accessed using a PID unique to the running program, such as the process ID or thread ID assigned by the operating system scheduler.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Commercial software products may be vulnerable to code injection attacks against stack variables. For example, if a return address is changed, it may cause buffer overflows, format string errors, and integer overflows. This type of software corruption may lead to injection and execution of arbitrary code by an attacker.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for detecting stack alteration as shown in and/or described in connection with at least one of the figures, as set forth more completely in the claims. Advantages, aspects and novel features of the present invention, as well as details of an illustrated embodiment thereof, will be more fully understood from the following description and drawings.

### BRIEF DESCRIPTION OF THE DRAWINGS

FIG. 1 is a block diagram that illustrates a first exemplary system for detecting a stack alteration in accordance with a representative embodiment of the present invention;

FIG. 2 is a block diagram that illustrates a second exemplary system for detecting a stack alteration in accordance with a representative embodiment of the present invention;

FIG. 3 is a flow diagram that illustrates a first exemplary method for detecting a stack alteration in accordance with a representative embodiment of the present invention; and

FIG. 4 is a flow diagram that illustrates a second method for detecting a stack alteration in accordance with a representative embodiment of the present invention.

### DETAILED DESCRIPTION OF THE INVENTION

Aspects of the present invention relate to employing one or more of machine instructions (i.e. assembler language instructions) in a Central Processing Unit (CPU) to detect stack alterations. Aspects of the present invention also relate to employing one or more associated CPU registers to detect stack alterations. Aspects of the present invention also relate to employing CPU logic to detect stack alterations. Aspects of the present invention may also relate to employing hidden content addressable memory (CAM) and registers that are only accessible by the CPU, and each cell in the CAM may be accessed using a PID (processed, threaded) unique to the running program, such as the process ID or thread ID assigned by the operating system scheduler. The detection of stack alterations may enable the defeat of code injection via stack alteration attacks and otherwise corrupted stack frame memory leading to unpredictable or arbitrary program execution behavior.

The aspects of the present invention will be described in connection with registers and instructions. The nomenclature of these particular elements is merely illustrative and is not intended to limit the scope of the present invention. An exemplary table of registers is shown in Table 1, and an exemplary table of machine instructions is shown in Table 2.

TABLE 1
Registers

| | |
|---|---|
| RAC | Return Address Copy register |
| CFR | Current Function Register |
| SFS | Stack Frame Signature register |
| SSCR | Stack Security Control Registers |

### Content Addressable Memory (CAM)

The CAM may be hidden from the software and may be a dedicated resource of the CPU that contains registers and memory cells. The CPU instructions may store stack frame information and stack frame signatures in memory cells and hidden registers. The registers and memory cells may be indexed using an ID number which is unique to each running process or thread. The unique ID number may be the process ID or thread ID assigned by the operating system scheduler running on the CPU, where each running thread or process has a unique ID number allowing it to be scheduled and executed. Using the unique PID as an identifier, each running process or thread may have a unique set of registers assigned to use in the CAM as required by each machine instruction named in this invention to store stack information and stack frame signatures.

### RAC Register

The Return Address Copy (RAC) register may be a hidden register that is not accessed by software and may only be accessed by the CPU. The RAC may take an ID as an argument. For example, the ID may be a thread ID, a task ID or a process ID (PID). The RAC may be stored in content-addressable memory based on the ID. The RAC may be loaded with a stack return address. The RAC may also be checked to verify the stack return address has not been altered.

### CRF Register

The Current Function Register (CFR) may contain the address of the current function and may only be accessed by the CPU. The CFR may be a hidden register that is not accessed by software. The CFR may be stored in content-addressable memory based on an ID. For example, the ID may be a thread ID, a task ID or a process ID (PID).

### SFS Register

The Stack Frame Signature (SFS) register may contain a signature of the stack frame region. A signature is computed over the said stack frame region and the signature may be, for example, any cryptographic hash function, such as Message-Digest algorithm 5 (MD5) or a cyclic redundancy check (CRC). The SFS register may be a hidden register that is not accessed by software. The SFS register may be stored in content-addressable memory based on an ID. For example, the ID may be a thread ID, a task ID or a process ID (PID).

### SSCR Control Registers

The Stack Security Control Register(s) (SSCR) may control a CPU's behavior when faults are detected. For example, the SSCR may be set to a default fail-safe state, to pause, to generate an interrupt, or to halt.

TABLE 2
Machine Instructions

| | |
|---|---|
| SRA | Save Return Address |
| RETSR | RETurn if Secure Return address |
| SFS | Stack Frame Signature |
| RETSS | RETurn if Secure Stack frame signature |

### SRA Instruction

The Save Return Address (SRA) instruction may save the return address from the stack into the RAC register. The SRA instruction may also save the address of the current function in the CFR. The SRA instruction may be used on entry to a protected function. The SRA instruction may take an ID as an argument. For example, the ID may be a thread ID, a task ID or a process ID (PID).

### RETS Instruction

The RETurn if Secure Return address (RETSR) instruction may return if the RAC register is equal to the return address on stack. Otherwise the RETSR instruction may perform as determined by the SSCR if the return address is altered. The RETSR instruction may take an ID as an argument. For example, the ID may be a thread ID, a task ID or a process ID (PID).

### SFS Instruction

The Stack Frame Signature (SFS) instruction may create a stack frame signature between two stack points and save the signature in the SFS register. The SFS instruction may require two arguments that define a stack frame region. The stack frame region may include all or part of the stack. The SFS instruction may also save the address of current function in the CFR. The SFS instruction may be used on entry to a protected function. The SFS instruction may take an ID as an argument. For example, the ID may be a thread ID, a task ID or a process ID (PID).

### RETSS Instruction

The RETurn if Secure Stack frame signature (RETSS) instruction may return if the SFS register matches the signature of the stack frame region indicated by the ID. For example, the ID may be a thread ID, a task ID or a process ID (PID). Otherwise the RETSS instruction may perform as determined by the SSCR if the signature is wrong. The RETSS instruction may take an ID as an argument.

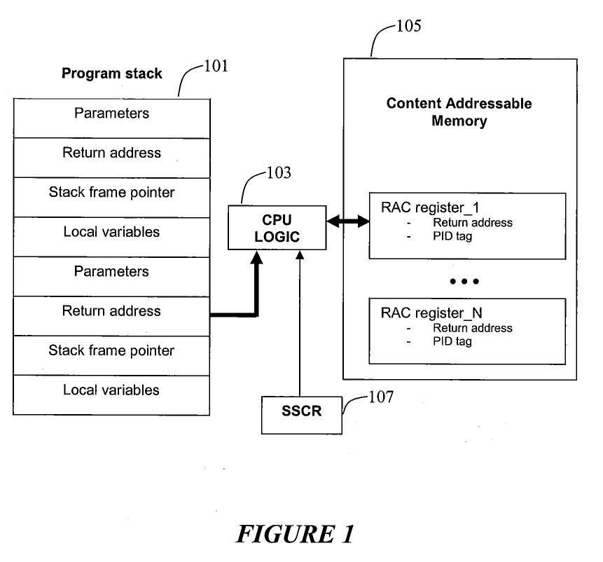

FIG. 1 illustrates a first exemplary system for detecting a stack alteration in accordance with a representative embodiment of the present invention. A program stack, 101, may include parameters, return addresses, stack frame pointers, and local variables. Content addressable memory, 105, may include CPU registers such as the RAC register.

Invoking the SRA instruction may cause CPU logic, 103, to extract information from the stack, 101, and store that information into the content-addressable registers, 105, keyed by the PID. For example, the PID may be a thread ID, a task ID or a process ID (PID) and is used as a lookup key. A copy of the return address may be saved to the invisible RAC register using the SRA instruction.

CPU logic, 103, may also read register information based on PID to compare current stack frame information with content-addressable registers. If the RETSR instruction is invoked and the return address is altered, the CPU logic may perform as determined by the SSCR, 107.

Additionally, CPU logic, 103, may ensure that SRA instruction is not invoked two or more times in a row without an intervening RETSR called first to ensure that arbitrary code does not over-write the initial information created from the SRA instruction. Detection of an attempt to invoke the SRA instruction twice in a row without an intervening RETSS being called first may generate interrupts as per the programming of the SSCR register. Table 3 is an illustrative use of the SRA and RETS instructions.

TABLE 3

| address | label | instruction |
|---|---|---|
| 10000000 | function1 | push parameter1 |
| | | push parameter2 |
| | | Call function2 |
| | | . . . |
| | | Program logic . . . |
| | | . . . |
| 10000800 | function2 | SRA, PID |
| | | . . . |
| | | Program logic . . . |
| | | . . . |
| | | RETS, PID |
| | | *NOTE: if stack frame not secure, raise |
| | | interrupt or halt CPU according to settings in |
| | | SSCR control register |

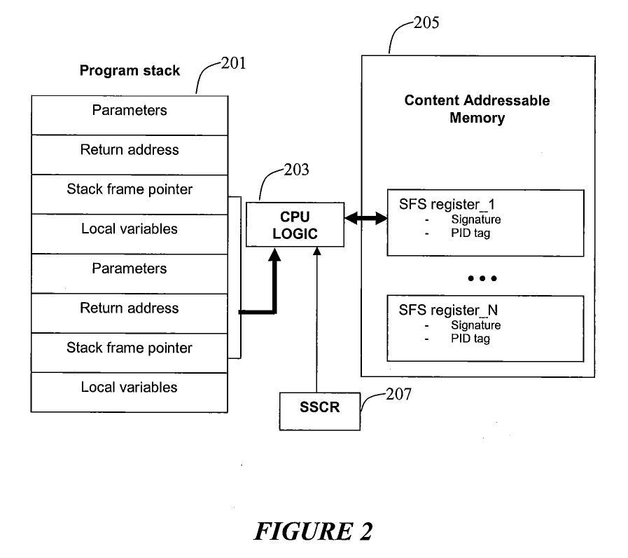

FIG. 2 illustrates a second exemplary system for detecting a stack alteration in accordance with a representative embodiment of the present invention. A program stack, 201, may include elements such as parameters, return addresses, stack frame pointers, and local variables. Content addressable memory, 205, may include CPU registers such as the SFS register.

Invoking the SFS instruction may cause CPU logic, 203, to extract information from the stack, 201, calculate a stack frame signature, and store that information into the content-addressable registers, 205, keyed by the PID. The stack frame signature may be computed from the value in one or more frame pointers. Alternatively, the stack frame signature may be a function of one or more stack elements. For example, the signature may be a cryptographic hash function such as Message-Digest algorithm 5 (MD5) or a cyclic redundancy check (CRC) computed over a stack region. A copy of the signature may be saved to the invisible SFS register using the SFS instruction.

CPU logic, 203, may also read register information based on PID to compare current stack frame information with content-addressable registers. If the RETSS instruction is invoked and the stored signature is not the same as a recomputed signature, the CPU logic may perform as determined by the SSCR, 207.

Additionally, CPU logic, 203, may ensure that SFS instruction is not invoked two or more times in a row without an intervening RETSS called first to ensure that arbitrary code does not over-write the initial information created from the SFS instruction. Detection of an attempt to invoke the SFS instruction twice in a row without an intervening RETSS called first may generate interrupts as per the programming of the SSCR register. Table 4 is an illustrative use of the SFS and RETSS instructions.

TABLE 4

| address | label | instruction |
|---|---|---|
| 10000000 | function1 | push parameter1 |
| | | push parameter2 |
| | | Call function2 |
| | | . . . |
| | | Program logic . . . |
| | | . . . |
| 10000800 | function2 | SFS, stack_point1, stack_point2, PID |
| | | . . . |
| | | Program logic . . . |
| | | . . . |
| | | RETSS, PID |
| | | *NOTE: if stack frame not secure, raise |
| | | interrupt or halt CPU according to settings in |
| | | SSCR control register |

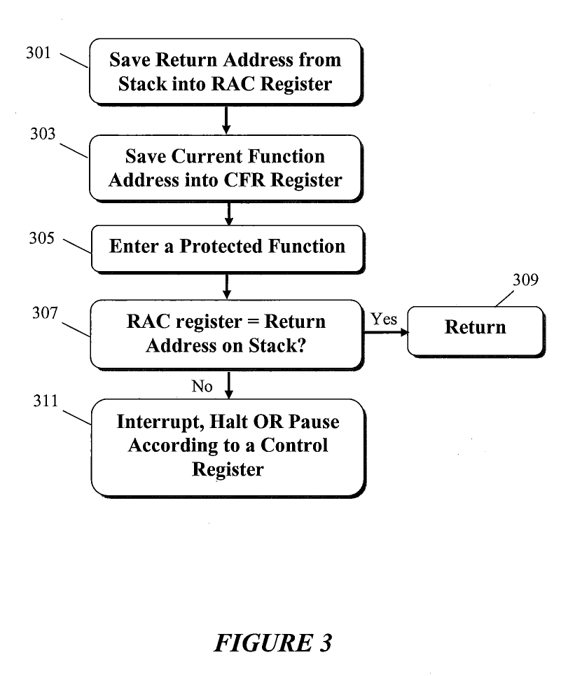

FIG. 3 is a flow diagram that illustrates a first exemplary method for detecting a stack alteration in accordance with a representative embodiment of the present invention. At 301, the Return Address from Stack may be saved into a RAC register. The RAC register may be a hidden register that is not accessed by software. The RAC may be stored in content-addressable memory based on the PID. For example, the PID may be a thread ID, a task ID or a process ID (PID) and is used as a lookup key.

At 303, the Current Function Address may be saved into a CFR register. The CFR register may also be a hidden register that is content-addressable based on the PID. For example, the PID may be a thread ID, a task ID or a process ID (PID) and is used as a lookup key. It may be desirable to invoke an instruction to store the return address prior to entering a protected function, 305.

Upon exiting the protected function, the RAC may be checked to verify the stack return address, 307. If the RAC register value matches the stack return address, the program may return, 309. However, if the RAC register value does not match the stack return address, the CPU may interrupt the program, halt or pause according to a control register, 311.

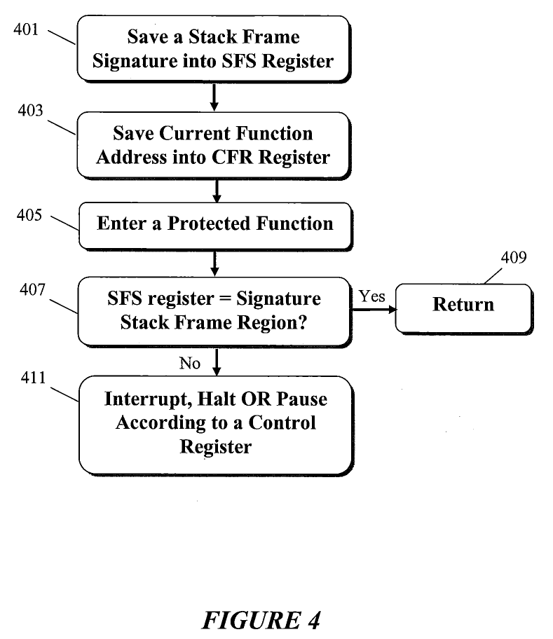

FIG. 4 is a flow diagram that illustrates a second method for detecting a stack alteration in accordance with a representative embodiment of the present invention. At 401, stack frame signature may be computed and stored into an SFS register. The SFS register may be a hidden register that is not accessed by software. The SFS may be stored in content-addressable memory based on the PID.

At 403, the Current Function Address may be saved into a CFR register. The CFR register may also be a hidden register that is content-addressable based on the PID. It may be desirable to invoke an instruction to store the stack frame signature prior to entering a protected function, 405.

Upon exiting the protected function, the SFS may be checked to verify the stack frame region, 407. If the SFS register value matches a recomputed stack frame signature, the program may return, 409. However, if the SFS register value does not match the recomputed stack frame signature, the CPU may interrupt the program, halt or pause according to a control register, 411.

The present invention may be realized in hardware, software, or a combination of hardware and software. The present invention may be realized in a centralized fashion in an integrated circuit such as a CPU (central processing unit) as a set of machine instructions expressed in assembler language or other computer language or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for detecting alterations in a program stack, wherein the system comprises:
a hidden register in content addressable memory; and
a logic circuit for storing a first stack variable in the hidden register according to an identification variable in a first instruction,
wherein the logic circuit locates the hidden register according to the identification variable in a second instruction and compares the first stack signature variable to a second stack variable.

2. The system of claim 1, wherein the first stack variable is a first return address and the second stack variable is a second return address.

3. The system of claim 1, wherein the first stack variable is a first stack pointer and the second stack variable is a second stack pointer.

4. The system of claim 1, wherein the first stack variable is a first stack signature and the second stack variable is a second stack signature.

5. The system of claim 4, wherein the logic circuit computes the first stack signature based on one or more elements of the program stack.

6. The system of claim 5, wherein the logic circuit computes the second stack signature based on one or more elements of the program stack at a time after the first stack signature is computed.

7. The system of claim 1, wherein the logic circuit returns if the first stack variable is equal to the second stack variable.

8. The system of claim 1, wherein the logic circuit performs according to a control register if the first stack variable is different than the second stack variable.

9. The system of claim 1, wherein the logic circuit performs according to a control register if the first instruction is called more than once before the second instruction is called.

10. The system of claim 1, wherein the logic circuit interrupts a program if the first stack variable is different than the second stack variable.

11. The system of claim 1, wherein the logic circuit pauses a program if the first stack variable is different than the second stack variable.

12. The system of claim 1, wherein the logic circuit halts a program if the first stack variable is different than the second stack variable.

13. A method for detecting an alteration in a program stack, wherein the method comprises:
storing a first stack variable in a hidden register at a first time, wherein the hidden register is located according to an identification variable; and
comparing the first stack variable to a second stack variable at a second time, wherein the second time follows the first time.

14. The method of claim 13, wherein the method comprises calling a protected function between the first time and the second time.

15. The method of claim 13, wherein the method comprises storing a current function address in another hidden register.

16. The method of claim 13, wherein the first stack variable is a first return address and the second stack variable is a second return address.

17. The method of claim 13, wherein the first stack variable is a first stack pointer and the second stack variable is a second stack pointer.

18. The method of claim 13, wherein the first stack variable is a first stack signature and the second stack variable is a second stack signature.

19. The method of claim 18, wherein the first stack signature is computed based on one or more elements of the program stack at the first time.

20. The method of claim 19, wherein the second stack signature is computed based on one or more elements of the program stack at the second time.

21. The method of claim 13, wherein the method comprises returning if the first stack variable is equal to the second stack variable.

22. The method of claim 13, wherein the method comprises executing an operation according to a control register if the first stack variable is different than the second stack variable.

23. The method of claim 13, wherein the method comprises interrupting a program if the first stack variable is different than the second stack variable.

24. The method of claim 13, wherein the method comprises pausing a program if the first stack variable is different than the second stack variable.

25. The method of claim 13, wherein the method comprises halting a program if the first stack variable is different than the second stack variable.

26. The method of claim 13, wherein the method comprises generating an interrupt if, prior to comparing the first stack variable to the second stack variable, an attempt to store a third stack variable in the hidden register is detected.
